(19) United States
(12) Patent Application Publication
(10) Pub. No.: US 2002/0035634 A1
(43) Pub. Date: Mar. 21, 2002

(54) Data exchange method and communication protocol used during same

(76) Inventors: Nadine Smolarski-Koff, Toronto (CA); David A. Koff, Toronto (CA); Marcus Shawky, La Breviere (FR)

Correspondence Address: MERCHANT & GOULD PC, P.O. BOX 2903, MINNEAPOLIS, MN, 55402-0903, US

(21) Appl. No.: 09/888,046

(22) Filed: Jun. 22, 2001

Related U.S. Application Data
(60) Provisional application No. 60/213,994, filed on Jun. 26, 2000.

(51) Int. Cl. G06F 15/16; G06F 17/30; G06F 17/60

(52) U.S. Cl. 709/230; 709/206; 705/3; 707/9; 707/10; 707/104.1

(57) ABSTRACT

A computerized method of creating a data message for electronic transmission to a recipient includes selecting at least one image file to be included in the data message. Exchange rights for the recipient are determined and establish at least one action available to the recipient with respect to handling of the at least one image file. The at least one image file and the exchange rights are then bundled to form the data message.

### FIELD OF THE INVENTION

The present invention relates in general to data communications and more specifically to a data exchange method and communication protocol used during the same.

### BACKGROUND OF THE INVENTION

In the medical field, data concerning a single patient is often collected and kept at a number of locations. For example, an individual may have a medical file with a general practitioner, a medical file with a specialist, a medical file or files at a hospital etc. As a result, at any one location, a patient's medical history is incomplete.

In the past, this problem even existed within hospitals where individual patients' records were kept by the various departments in the hospitals. With the introduction of database management systems and the move to computer networking solutions, this distributed information problem within hospitals has been reduced significantly. The use of computer networks has allowed patient records to be stored in a common database and accessed and updated from workstations throughout the hospital.

To deal with medical images, many hospitals use picture archiving and communication systems that enable medical images to be stored in a common database and exchanged between workstations. These picture archiving and communication systems have typically been implemented over Intranet architectures within the computer networks and make use of the Transmission Control Protocol/Internet Protocol (TCP/IP) suite of protocols during data exchange. Although the emergence of the Internet has opened communication channels between computer workstations at geographically separated locations, due to the confidential nature of medical data and the need to ensure data integrity, picture archiving and communication systems have to-date, only permitted data exchange within hospitals.

Although picture archiving and communication systems have typically only permitted data exchange within hospitals, there is a need to be able to transmit medical image data securely across Internet connections. It is therefore an object of the present invention to provide a novel data exchange method and communication protocol used during the same.

### SUMMARY OF THE INVENTION

According to one aspect of the present invention there is provided a computerized method of creating a data message for electronic transmission to a recipient comprising the steps of:

selecting at least one image file to be included in said data message;

determining exchange rights for said recipient, said exchange rights establishing at least one action available to said recipient with respect to handling of said at least one image file; and

bundling said at least one image file and said exchange rights to form said data message.

Preferably, during the selecting at least one image annotation, audio and/or text file related to the at least one image file is included in the data message. During the determining, preferably different categories of exchange rights are examined to locate the category the recipient to which has been assigned. If the recipient has not been assigned to a category, the recipient is assigned default exchange rights. In the preferred embodiment, the exchange rights determine whether the recipient is permitted to browse the at least one image file and related files, browse and archive the at least one image file and related files, browse and forward the at least one image and related files, or browse, archive and forward the at least one image and related files.

Preferably, prior to bundling, clear text in a selected related text file is encrypted and selected audio and/or text files are encoded. After bundling it is preferred that the data message is encrypted and MIME encoded.

According to another aspect of the present invention there is provided a computerized method for controlling actions available to a recipient receiving a data message from a sender, said method comprising the steps of:

creating a data message that includes at least one image file and exchange rights for said recipient, said exchange rights establishing at least one action available to said recipient with respect to handling of said at least one image file;

transmitting said data message to a computer system of said recipient;

deconstructing said data message at said recipient computer system to determine the exchange rights therein; and

permitting said recipient to perform said at least one action with said at least one image file in accordance with said exchange rights.

Preferably, the exchange rights include browse only, browse and archive, browse and forward, and browse, archive and forward rights. When a data message is transmitted, a flag is set. If a receipt acknowledgement is not received from the recipient computer system within a threshold period of time, a message prompt is generated to notify the sender.

According to yet another aspect of the present invention there is provided a computerized method for communicating a data message between a sender and a recipient comprising the steps of:

from a computer system of said sender, transmitting a data message to a computer system of said recipient, said data message including at least one image file and exchange rights for said recipient, said exchange rights establishing whether said recipient is permitted to browse said at least one image file, browse and archive said at least one image file, browse and forward said at least one image file, or browse, archive and forward said at least one image file;

at the recipient computer system upon receipt of said data message, deconstructing said data message to determine the exchange rights therein; and

permitting said recipient to handle said at least one image file in accordance with said exchange rights.

Preferably, the method further includes transmitting a reply data message to the sender computer system. When a reply data message is transmitted, a flag is set. If a receipt acknowledgement is not received from the original sender computer system within a threshold period of time, a message prompt is generated to notify the recipient. The reply data message includes at least one audio and/or text file and the exchange rights of the original data message.

According to still another aspect of the present invention there is provided a data message structure comprising:

at least one image file; and

an exchange rights file, said exchange rights file including data fields complimentary to data fields in said at least one image file, the data fields in said exchange rights file specifying at least one recipient who is permitted access to said at least one image file and being linked to said at least one image file.

The present invention provides advantages in that it permits sensitive image data to be transmitted over the Internet in a data message that ensures image data integrity. This is achieved by assigning exchange rights to the image data, that determine whether the recipient is permitted to browse the image data, archive the image data and/or forward the image data to other recipients and by encrypting the data message to inhibit unauthorized parties from accessing the image data and the exchange rights. Whenever a data message including image data is conveyed between parties, acknowledgments are generated allowing the sender to confirm that the transmitted data message has been received. Data messages are sent in standard electronic mail (e-mail) format allowing IP address labelling to be used to direct the data messages to the desired recipients. Since e-mail addresses are used to direct data messages to recipients, the IP addresses of the recipients' computers remain hidden.

### BRIEF DESCRIPTION OF THE DETAILED DRAWINGS

An embodiment of the present invention will now be described more fully with reference to the accompanying drawings in which:

FIG. 1 is a schematic diagram of a data network;

FIG. 2 is a flowchart showing the steps performed during creation of an exam record including at least one image file;

FIG. 3 is a flowchart showing the steps performed during creation of a data message including an exam structure containing an exam record;

FIG. 4 is a flowchart showing the steps performed when a recipient receives an e-mail message including a data message;

FIG. 5 is a flowchart showing the steps performed when a recipient generates a reply e-mail message in response to a received e-mail message;

FIG. 6 is a flowchart showing the steps performed by a sender when a reply e-mail message is received from a recipient; and

FIG. 7 is a flowchart showing the steps performed by a recipient when forwarding an e-mail message that includes a data message to another recipient.

### DETAILED DESCRIPTION OF THE PREFERRED EMBODIMENT

The present invention relates to a data exchange method and protocol for exchanging data messages including image data between computer systems over a distributed computer network such as the Internet. Image data and related data to be sent from one computer system to another computer system is initially selected from a relational database. Exchange rights are then assigned to the image data that define at least one recipient permitted or entitled to browse the image data. The exchange rights also determine if the at least one recipient is permitted to archive the image data and/or permitted to forward the image data to another recipient. The exchange rights are appended to the image data and related data and the resulting data are bundled to form a data message. The data message is then encrypted and encoded placing it in a secure condition suitable for transmission to the destination computer system in a standard electronic mail (e-mail) format.

When the data message is transmitted to the destination computer system and received, the destination computer system automatically acknowledges receipt of the data message. If an acknowledgement is not received by the sending computer system within a specified period of time, a prompt is generated to alert the sender. Once the data message is received and delivered to the workstation of the designated recipient, the designated recipient is able to browse, archive and/or forward the image data in the data message (provided the exchange rights permit the recipient to do so). If the recipient appends information to the data message and replies to the sender, the appended information is bundled with the original exchange rights to form a reply data message. The reply data message is then transmitted to the sender computer system and does not include the original image data and related data. The appended information received by the sender is automatically integrated into the database of the sending computer system.

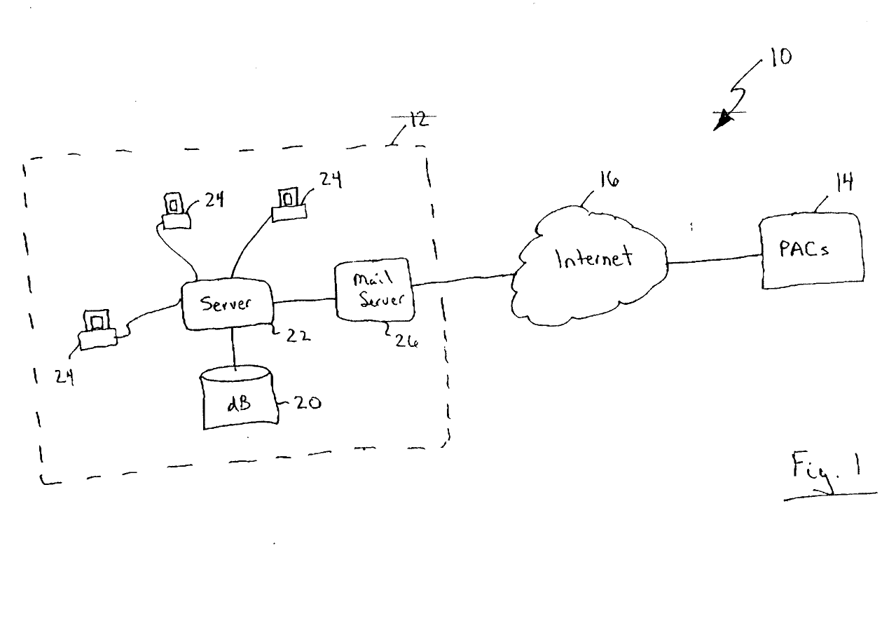

A preferred embodiment of the present invention will now be described with reference to FIGS. 1 to 7. Turning now to FIG. 1, a data network is shown and is generally identified by reference numeral 10. In this example, data network 10 includes a picture archiving and communication system (PACs) 12 within a medical facility. PACs 12 communicates with another PACs 14 at a different geographical location over the Internet 16. PACs 12 includes a relational database 20, in this example an SQL database, storing a plurality of exam records that include medical image data and related data as will be described. A server 22 communicates with the database 20 and with a plurality of workstations 24 distributed throughout the medical facility. In this manner, users can access the database 20 via the workstations 24. Server 22 also communicates with a mail server 26. Mail server 26 allows users to transmit data messages over the Internet 16 in a standard e-mail format.

Each exam record in the relational database 20 includes one or more related files linked by pointers. Specifically, each exam record includes at least one image file and optionally related image annotation, audio and/or text files. Image files included in each exam record are compressed using a wavelet algorithm and are digitally watermarked to ensure integrity. The compression parameters are computed according to image modality and are stored in a .dat file format. Image annotations in each exam record are in the form of graphic objects that are stored as independent files. When an image file and related image annotations are displayed, the graphic objects of the image annotations are superimposed on the displayed image file. Audio files in each exam record are stored in a .wav file format and text files in each exam record are stored either in .txt or .doc file format. Data compression and scrambling techniques are used to encode the audio and/or text files in each exam record.

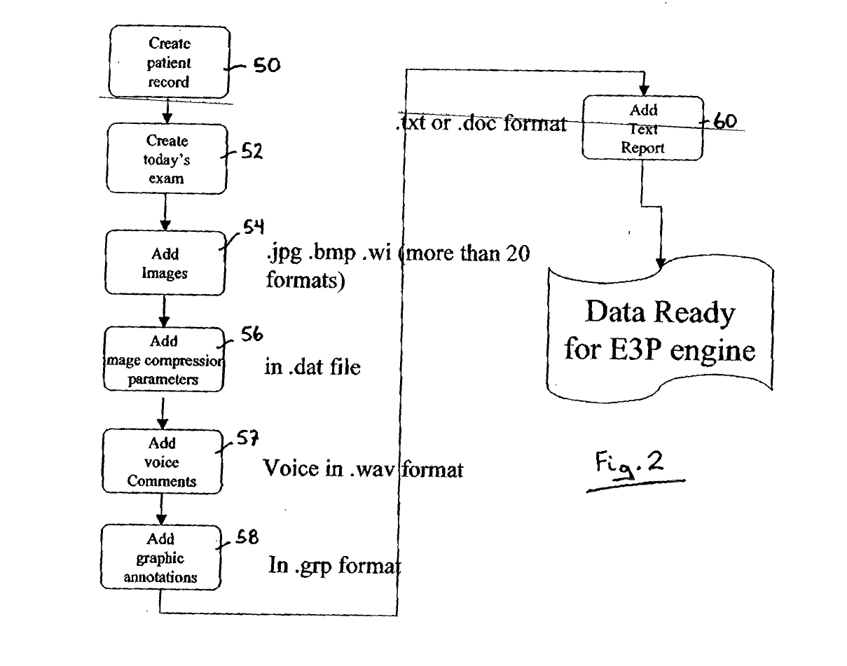

Turning now to FIG. 2, a flowchart showing the steps performed during creation of an exam record is shown. As can be seen, initially a patient record is created (step 50) followed by a current exam record (step 52). Once the exam record is created, the image file or files associated with the patient that are to be included in the exam record are compressed and stored in the exam record (step 54) together with the compression parameters used to compress the image file or files (step 56). Related image annotation, audio and/or text files are then stored in the exam record (steps 57, 58 and 60) to complete the exam record and the exam record is stored in the database 20.

Each of the workstations 24 executes a data message creation application that includes a graphical user interface (GUI). The data message creation application allows a user to create data messages that include image files and optionally related image annotation, audio and/or text files associated with an exam record, together with exchange rights that determine recipients permitted to browse the image and related files, archive the image and related files and/or forward the image and related files to other recipients.

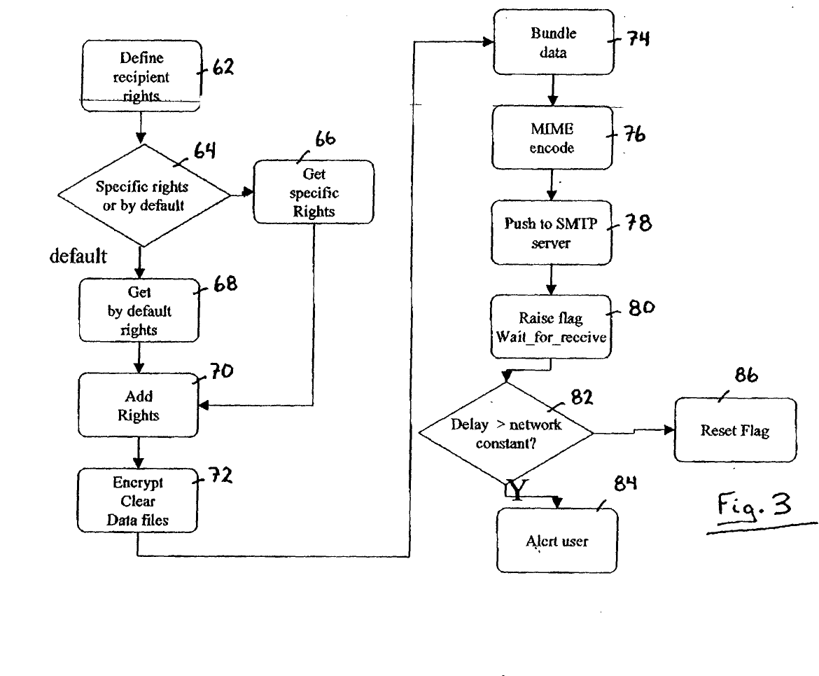

The GUI allows a user to create categories of exchange rights and assign recipients in their local address book to the created categories (see step 62 in FIG. 3). In this particular example, one category of exchange rights allows recipients only to browse image files. Another category of exchange rights allows recipients to browse image files and archive image files. Another category of exchange rights allows recipients to browse image files and forward image files to other recipients while yet another category of exchange rights allows recipients to browse image files, archive image files and forward image files to other recipients.

When the user wishes to create a data message, the exam records in the database 20 are exposed through the GUI. Using a computer pointing device, the user can open an exam record. Once an exam record has been opened, the image file or files, and related image annotation, audio and/or text files within the exam record appear as icons. Individual image files within the exam record and related image annotation, audio and/or text files can then be selected using the computer pointing device.

Once the desired files within the exam record have been selected and the recipient of the exam record is designated, the data message creation application checks to determine if the recipient has been assigned to an exchange rights category (step 64). If so, the exchange rights associated with the category to which the recipient has been assigned are selected (step 66). If the recipient has not been assigned to a category, default exchange rights are selected (step 68). Once the exchange rights for the recipient have been determined, the exchange rights are appended to the selected exam record files to form an exam structure (step 70).

The exchange rights are stored in independent files that include data fields complimentary to data fields in the exam record image file or files. The data fields are linked to the associated image file by file name. In this particular example, the data fields hold information that define user browsing rights, user archiving rights, the archiving duration and user forwarding rights.

After the exchange rights have been appended to the exam record image file or files, clear data files such as the text files in the exam structure are encrypted (step 72) and the exam structure is bundled (step 74) to complete the data message. Following this, the data message is encrypted and MIME encoded (step 76). The encrypted and MIME encoded data message is then attached to a conventional e-mail message and sent to the recipient PACs 14 over the Internet by the mail server 26 (step 78). A flag is then set to a “wait_for_receive” state (step 80). If an acknowledgement is received from the recipient PACs 14 confirming receipt of the e-mail message within a predetermined period of time (step 82), the wait_for_receive flag is reset (step 86). Otherwise, a message prompt is generated and sent to the sender's workstation 24 to notify the sender (step 84).

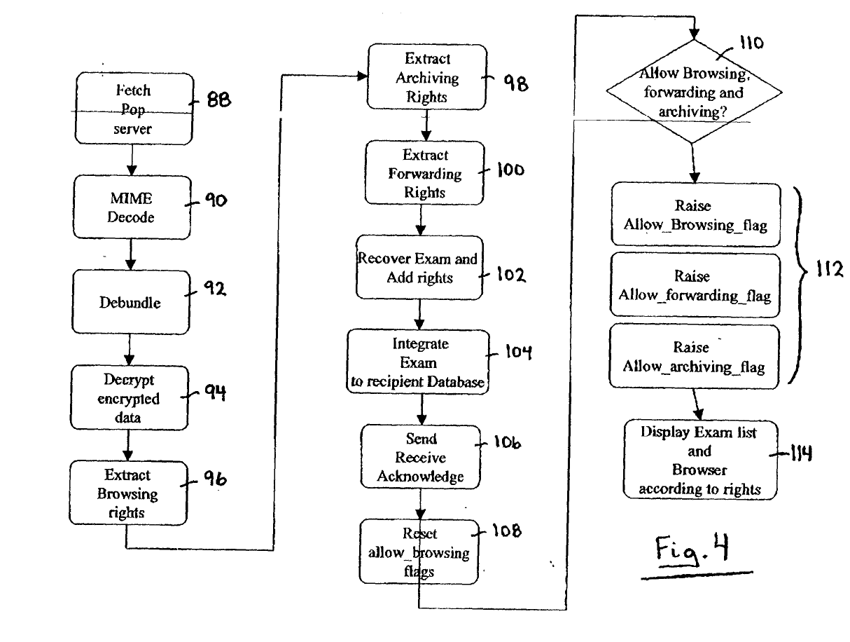

When the e-mail message arrives at the destination, the e-mail message is received by the mail server 26 PACs 14 and is delivered to the mailbox of the recipient. When the recipient retrieves the e-mail message, the data message is retrieved from the mail server (see step 88 in FIG. 4). Once retrieved, the data message is deconstructed firstly by MIME decoding and decrypting the data message (step 90). Afterwards, the data message is debundled (step 92) and all clear text files in the exam structure are decrypted (step 94). The exchange rights are then extracted from the exam structure starting with the browsing rights (step 96), then the archiving rights (step 98) and then the forwarding rights (step 100). The exam record image and related files are then recovered from the exam structure (step 102) and the exam record image and related files together with the exchange rights are cached (step 104). An acknowledgment is returned to the sender PACs 12 to verify receipt of the data message (step 106).

With the exam record image and related files cached and the receipt acknowledgement returned to the sender PACs 12, status flags associated with browsing, archiving and forwarding are reset (step 108). The exchange rights are then analyzed to check the browsing, archiving and forwarding rights (step 110). “Allow_browsing”, “Allow_forwarding” and “Allow_archiving” status flags are set to false if the associated exchange rights inhibit the recipient from browsing, archiving and/or forwarding image and related files in the record (steps 112). If the recipient has browsing rights, the image file or files and accompanying related image annotation, audio and/or text files can be displayed and/or reviewed (block 114). If the recipient has archiving rights, the image file or files and accompanying related image annotation, audio and/or text files can be stored in the database 20 for a duration determined by the archiving duration rights.

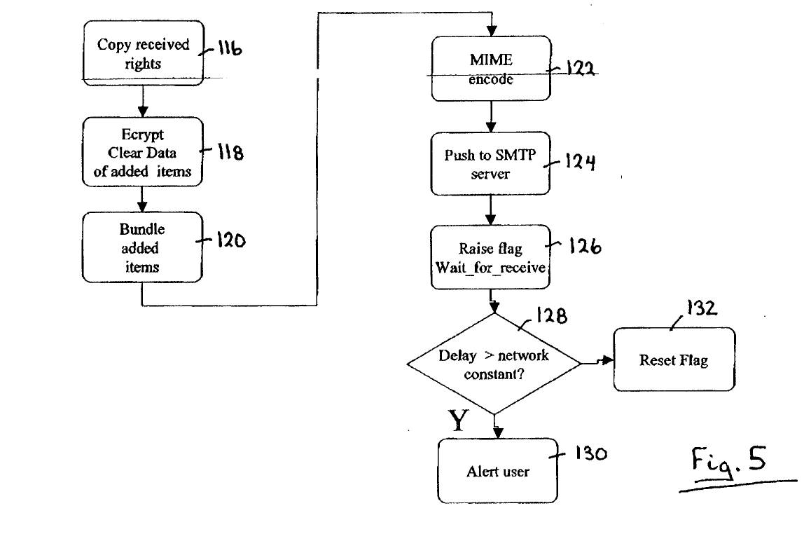

If the recipient elects to reply to the sender, the recipient can respond by creating an audio file and/or a text file. Once an audio and/or text file has been created, the created file and a copy of the original exchange rights are packaged to form an exam structure (see step 116 in FIG. 5). Any clear text in a created text file in the exam structure is encrypted (step 118) and the exam structure is bundled (step 120) to form a reply data message. The reply data message is then encrypted and MIME encoded (step 122) and is attached to a conventional e-mail message. The e-mail message is then sent to the sender PACs 12 by the mail server 26 over the Internet 16 (step 124). A flag is then set to a wait_for_receive state (step 126). If an acknowledgment is received from the original sender PACs 12 confirming receipt of the reply data message within a predetermined period of time (step 128), the flag is reset (step 132). Otherwise, a message prompt is generated and sent to the recipient's workstation 24 to notify the recipient (step 130).

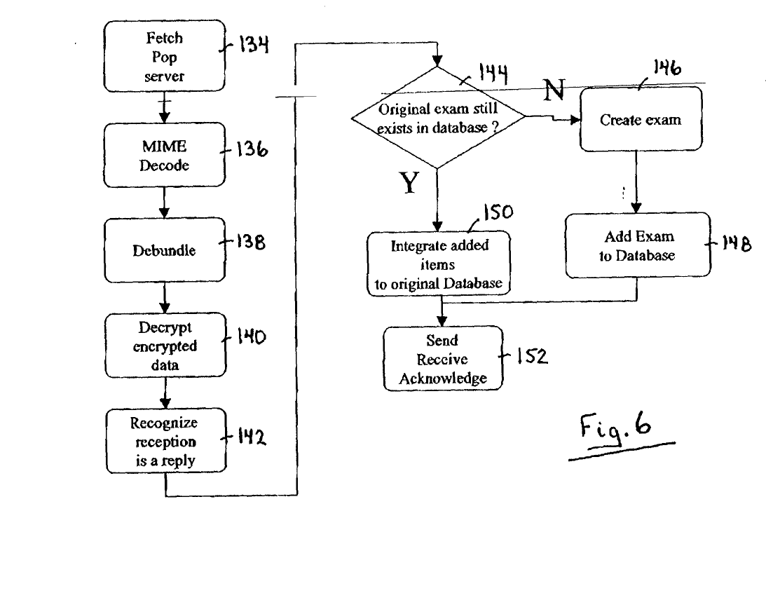

When the reply e-mail message arrives at PACs 12, the e-mail message is received by the mail server 26 and is delivered to the mailbox of the original sender. When the original sender retrieves the e-mail message, the reply data message is retrieved from the mail server 26 (see step 134 in FIG. 6). Once retrieved, the reply data message is MIME decoded and decrypted (step 136) and the reply data message is debundled (step 138). All clear text files in the exam structure are then decrypted (step 1450). The exam structure is examined to confirm it relates to a reply (step 142) and then the database 20 is examined to determine if an exam record exists in the database that relates to the reply (step 142).

If an exam record exists in the database 20, the audio and/or text files in the reply data message are added to the exam record in the database (step 150). If an exam record does not exist in the database 20, a new exam record is created in the database (step 146) and the audio and/or text files in the reply data message are added to the new exam record (step 148). Once the audio and/or text files have been stored in the database 20 either at step 108 or step 110, an acknowledgment is returned to the recipient PACs 14 to confirm receipt of the reply data message (step 152).

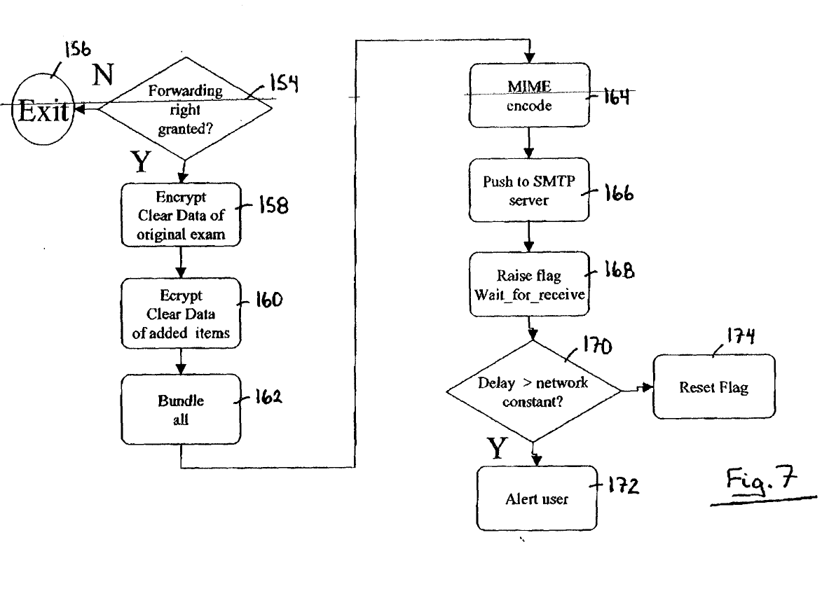

If the recipient elects to forward the data message to another recipient, the forwarding rights are examined (see step 154 in FIG. 7). If the recipient does not have forwarding rights, the recipient is inhibited from performing this task (step 156). If the recipient has forwarding rights, the local address book of the recipient is checked to determine if the new recipient has been assigned exchange rights. Exchange rights assigned by the recipient can further restrict the rights of the new recipient but not expand the exchange rights established by the original sender. If the new recipient has been assigned exchange rights that further restrict the rights of the new recipient, those exchange rights are included in the exam structure. Otherwise the exchange rights established by the original sender are included in the exam structure. Following this, clear text in text files in the original exam structure are encrypted (step 158) and clear text in text files appended to the exam structure by the recipient are also encrypted (step 160). The exam structure and appended files are bundled (step 162) to form the forwarding data message and the forwarding data message is encrypted and MIME encoded (step 164). Following this, the forwarding data message is attached to a conventional e-mail message and is forwarded to the new recipient by the mail server (step 166). A flag is then set to a wait_for_receive state (step 168). If an acknowledgment is received from the new recipient PACs confirming receipt of the forwarding data message within a predetermined period of time (step 170), the flag is reset (step 174). Otherwise, a message prompt is generated and sent to the recipient's workstation to notify the recipient (step 172).

As will be appreciated, the present invention permits sensitive image data to be transmitted over the Internet while ensuring data integrity. This is achieved by assigning exchange rights to image data, which determine recipients permitted to browse the image data, archive the image data and/or forward the image data and by encrypting the data message to inhibit unauthorized access to the image data and exchange rights. Whenever image data is conveyed between parties, acknowledgments are generated allowing the sender of the data message to confirm that the transmitted data message was received.

Although a preferred embodiment of the present invention has been described herein in detail, it will be understood by those skilled in the art that variations and modifications may be made without departing from the spirit and scope thereof as defined by the appended claims.

What is claimed is:

1. A computerized method of creating a data message for electronic transmission to a recipient comprising the steps of:
selecting at least one image file to be included in said data message;
determining exchange rights for said recipient, said exchange rights establishing at least one action available to said recipient with respect to handling of said at least one image file; and
bundling said at least one image file and said exchange rights to form said data message.

2. The method of claim 1 wherein said selecting further includes selecting at least one image annotation, audio and/or text file related to said at least one image file.

3. The method of claim 2 wherein said at least one image file and related at least one image annotation, audio and/or text file are included in an exam record stored in a database, during said selecting, said exam record being opened to expose the files therein through a user interface thereby to enable files in said exam record to be selected.

4. The method of claim 3 wherein said user interface is a graphical user interface and wherein files of said exam record are selected using a computer pointing device.

5. The method of claim 1 wherein during said determining different categories of exchange rights are examined to locate the category to which said recipient has been assigned thereby to determine the exchange rights for said recipient.

6. The method of claim 5 wherein during examination of the different categories of exchange rights, if the recipient is not located, default exchange rights are assigned to said recipient.

7. The method of claim 5 wherein said different categories of exchange rights include browse only, browse and archive, browse and forward, and browse, archive and forward exchange rights.

8. The method of claim 2 further comprising the step of encrypting clear text in a selected related text file prior to said bundling.

9. The method of claim 2 further comprising the step of encoding selected audio and/or text files prior to said bundling.

10. The method of claim 9 wherein said encoding includes at least one of compressing and scrambling said audio and/or text files.

11. The method of claim 1 further comprising the step of encrypting said data message after said bundling.

12. The method of claim 11 further comprising the step of MIME encoding said encrypted data message.

13. The method of claim 1 wherein said at least one image file is compressed.

14. The method of claim 13 wherein said at least one image file is compressed using a wavelet algorithm and wherein parameters for said compression are computed according to image modality.

15. The method of claim 14 wherein said compression parameters accompany said at least one image file and wherein said at least one image file is also digitally watermarked.

16. A computerized method for controlling actions available to a recipient receiving a data message from a sender, said method comprising the steps of:
creating a data message that includes at least one image file and exchange rights for said recipient, said exchange rights establishing at least one action available to said recipient with respect to handling of said at least one image file;
transmitting said data message to a computer system of said recipient;
deconstructing said data message at said recipient computer system to determine the exchange rights therein; and
permitting said recipient to perform said at least one action with said at least one image file in accordance with said exchange rights.

17. The method of claim 16 wherein said exchange rights are selected from the group consisting of browse only, browse and archive, browse and forward, and browse, archive and forward exchange rights.

18. The method of claim 17 further comprising the step of setting a flag following transmission of said data message to said recipient computer system and generating a prompt if a receipt acknowledgement is not received from said recipient computer system within a threshold period of time following said transmission.

19. The method of claim 16 wherein during said creating at least one image annotation, audio and/or text file related to said at least one image file is included in said data message.

20. The method of claim 19 wherein during said creating said at least one image file, said at least one related image annotation, audio and/or text file and said exchange rights are bundled to form said data message.

21. The method of claim 20 further comprising the step of encrypting clear text in each text file in said data message prior to said bundling.

22. The method of claim 21 further comprising the step of encoding each audio and/or text file in said data message prior to said bundling.

23. The method of claim 22 wherein said encoding includes at least one of compressing and scrambling each said audio and/or text file.

24. The method of claim 20 further comprising the step of encrypting said data message prior to said transmitting.

25. The method of claim 24 further comprising the step of MIME encoding said encrypted data message prior to said transmitting.

26. The method of claim 25 wherein during said deconstructing, said data message is MIME decoded, decrypted and debundled.

27. A computerized method for communicating a data message between a sender and a recipient comprising the steps of:
from a computer system of said sender, transmitting a data message to a computer system of said recipient, said data message including at least one image file and exchange rights for said recipient, said exchange rights establishing whether said recipient is permitted to browse said at least one image file, browse and archive said at least one image file, browse and forward said at least one image file, or browse, archive and forward said at least one image file;
at the recipient computer system upon receipt of said data message, deconstructing said data message to determine the exchange rights therein; and
permitting said recipient to handle said at least one image file in accordance with said exchange rights.

28. The method of claim 27 further comprising the step of setting a flag at said sender computer system following transmission of said data message to said recipient computer system and generating a prompt if a receipt acknowledgement is not received from said recipient computer system within a threshold period of time following said transmission.

29. The method of claim 28 wherein said data message further includes at least one image annotation, audio and/or text file related to said at least one image file.

30. The method of claim of claim 29 further comprising the step of at the recipient computer system, transmitting a reply data message to the sender computer system.

31. The method of claim 30 wherein said reply data message includes at least one audio and/or text file and said exchange rights.

32. The method of claim 31 further comprising the step of setting a flag at said recipient computer system following transmission of said data message to said sender computer system and generating a prompt if a receipt acknowledgement is not received from said sender computer system within a threshold period of time following said transmission.

33. The method of claim 32 further comprising the step of encrypting clear text in each text file in said data message and said reply data message prior to said transmitting.

34. The method of claim 33 further comprising the step of encoding each audio and/or text file in said data message and said reply data message prior to said transmitting.

35. The method of claim 34 further comprising the step of encrypting said data message and said reply data message prior to said transmitting.

36. A data message structure comprising:
at least one image file; and
an exchange rights file, said exchange rights file including data fields complimentary to data fields in said at least one image file, the data fields in said exchange rights file specifying at least one recipient who is permitted access to said at least one image file and being linked to said at least one image file.

37. The message structure of claim 36 wherein the data fields in said exchange rights file determine if said at least one recipient is permitted to browse said at least one image file.

38. The message structure of claim 37 wherein the data fields in said exchange rights file determine if said at least one recipient is permitted to archive said at least one image file and/or forward said at least one image file to another recipient.

39. The message structure of claim 38 wherein said at least one image file is compressed.

40. The message structure of claim 39 wherein said at least one image file is compressed using a wavelet algorithm and wherein parameters for said compression are computed according to image modality.

41. The method of claim 40 wherein said compression parameters accompany said at least one image file and wherein said at least one image file is also digitally watermarked.
